(19) United States
(12) Patent Application Publication
(10) Pub. No.: US 2008/0278434 A1
(43) Pub. Date: Nov. 13, 2008

(54) Driving Means for Electrowetting Displays

(75) Inventors: Roy Van Dijk, Eindhoven (NL); Theodorus Johannes Petrus Van Den Biggelaar, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJE PHILIPS ELECTRONICS N.V., Eindoven (NL)

(21) Appl. No.: 12/093,605

(22) PCT Filed: Oct. 27, 2006
(86) PCT No.: PCT/IB06/53966

§ 371 Date: May 14, 2008

(30) Foreign Application Priority Data
Nov. 15, 2005 (EP) 05110756.3

(51) Int. Cl. G09G 3/34; G02B 26/02

(52) U.S. Cl. 345/107

(57) ABSTRACT

The present invention relates to driving mean for an electrowetting display device having a picture element. The driving means is arranged to apply, prior to a data write signal (DT), a voltage signal (DS) to said picture element. Further, the voltage signal (DS) is arranged to have a duration and voltage level that allow said picture element to maintain their optical states.

The present invention relates to driving means for an electrowetting display device having a picture element. The driving means is arranged to apply, prior to a data write signal, a voltage signal to said picture element.

Electrowetting displays are becoming attractive to an ever increasing extent, mainly because of a combination of high brightness, a high contrast ratio, a large viewing angle and a fast switching speed. These properties make electrowetting displays suitable for video applications. In principle, electrowetting display can be made transmissive or reflective. For reflective electrowetting displays the power consumption can be relatively low, because no backlight is required.

An electrowetting display typically comprises a closed electrowetting cell, a polar and non-polar liquid, such as water and oil, having different optical properties and being contained in the cell, a number of electrodes for controlling the liquids contained in the cell, a front layer and a rear reflective layer. The liquids, which are immiscible, may be displaced by means of applying voltages to the electrodes. In an equilibrium-state (in which no voltages are applied to the electrodes) the polar and non-polar liquids are naturally layered in the closed cell, whereby a thin film is created. In this state, a colored state, the film covers the reflective area and the cell or pixel appears dark or black. By applying a voltage across the electrodes, the layered, colored state is no longer energetically favorable and the cell or pixel may lower its energy by moving the polar liquid towards one of the comers of a pixel. As a result the non-polar liquid is displaced and the underlying reflective or white surface is exposed. Consequently, in this state, a white state, the cell or pixel appears white or bright. The interaction between electrostatic and capillary forces determines how far the non-polar liquid is displaced to the side. In this manner, the optical properties of the layered composition may be adjusted such that intermediate color states, i.e. states lying between the colored state and the white state, are achieved.

Patent application WO 2005/036517 A1 discloses a display device comprising picture elements having at least a first fluid and a second fluid immiscible with each other above a first transparent support plate, the second fluid being electro-conductive or polar. Further, driving means of a display, providing pre-pulses, is disclosed. The pre-pulses bring the picture elements of the display device into electro-optical states associated with the voltage levels of the pre-pulses. When driving an electrowetting display device of this type, each row must accordingly be selected twice (two times for each frame). A first selection signal is setting the picture elements in an optical state associated with the applied voltage level, and a second selection signal is writing data to the pixels. A problem of the prior art disclosed in the abovementioned patent document is that the pre-pulses produce an optical response, which may become visible when longer pre-pulses are used.

An object of the present invention is, inter alia, to solve this problem in the prior art, and to this end, there is provided driving means as set forth in the appended independent claim 1 and a method as defined by independent claim 11. Specific embodiments are defined in the dependent claims.

The inventors have found that the a desired optical state can be better maintained for its desired period of time if a voltage signal is applied to the picture element which is different from the writing signal used for bringing the picture element into and maintaining the desired optical state, which voltage signal has a voltage level and duration such that the optical state is substantially maintained between for and after application of such voltage signal. In particular, the voltage signal prevents backflow of the oil.

The optical state of a picture element refers to the optical appearance of the picture element. For instance, the picture element of a grey scale display may attain any one of the extreme optical states black or white or different intermediate optical states in-between the extreme states, i.e. different levels of grey. As should be understood, the optical state of a picture element may further refer to different color levels (in case of a color display), luminance levels, levels of reflectivity, etc.

Normally, when a picture element is switched to an open, white state, wherein the oil of the electrowetting cell is displaced, the oil slowly returns to a fully closed, colored state, in which the oil creates a layer over the entire electrowetting cell. In this state the picture element appears dark. Depending on the characteristics of the oil, this may take from about only half a second to tenths of seconds. This phenomenon is referred to as back flow and seems to originate from electrical charging of the picture element. It has been found that the application of a voltage signal reduces the charging of the picture element. The duration of the voltage signal is such that the optical state of the picture element substantially does not change when the signal is applied. This implies that the optical state of the picture element in principal is maintained. If the optical state is slightly altered by the voltage signal such that the picture element attains a new optical state, this new state is preferably close to the state that the picture element had when the signal was applied, such that a viewer does not perceive any substantive change in optical state. However, electrical properties of the picture element, such as voltage charged across the picture element or capacitance of the picture element, may very well change when the voltage signal is applied.

In a first embodiment of the invention, there is provided driving means, which is arranged such that a plurality of data write signals can be applied to the picture element within a frame, whereby the frame time of the display device may be decreased.

In an embodiment of the invention, the driving means is arranged to apply the voltage signal to a picture element having an optical state in a first frame such that the picture element has the same optical state in a second frame. Hence, the grey level of a picture element may advantageously be employed over time and over several frames.

In a first embodiment of the invention, the voltage level of the voltage signal is set to zero volt. Advantageously, a voltage level of zero volt provides a minimal charge on the picture element. A voltage level of less than one sixth of the data write signaling voltage may be used to approximate a zero-volt signal, i.e. if the driving voltage is −30 V, the approximated value would be from −5 V to 5 V.

Moreover, the voltage signal may have a duration of 2 to 15% of the frame time, more specifically about 10% of the frame time. The frame time is the duration of a frame. For a frame updating frequency of e.g. 50 Hz, the frame time is 20 ms. An advantage with applying a voltage signal of a short duration as specified above is that it allows electrical properties of the picture element to be changed without changing the optical state of the picture element.

In another embodiment of the present invention, the driving means is arranged to apply at least one voltage signal for each picture element within one frame. In this manner, consistent and frequent discharging of the picture elements is ensured. Advantageously, the optical state may be maintained for a plurality of picture elements over time.

Furthermore, there is provided an electrowetting display device comprising the driving means according to an embodiment of the invention. The display device comprises, according to another embodiment of the present invention, an active matrix display device. Further features of, and advantages with, the present invention will become apparent when studying the appended claims and the following description. Those skilled in the art realize that different features of the present invention can be combined to create embodiments other than those described in the following.

The various aspects of the invention, including its particular features and advantages, will be readily understood from the following detailed description and the accompanying drawings, in which:

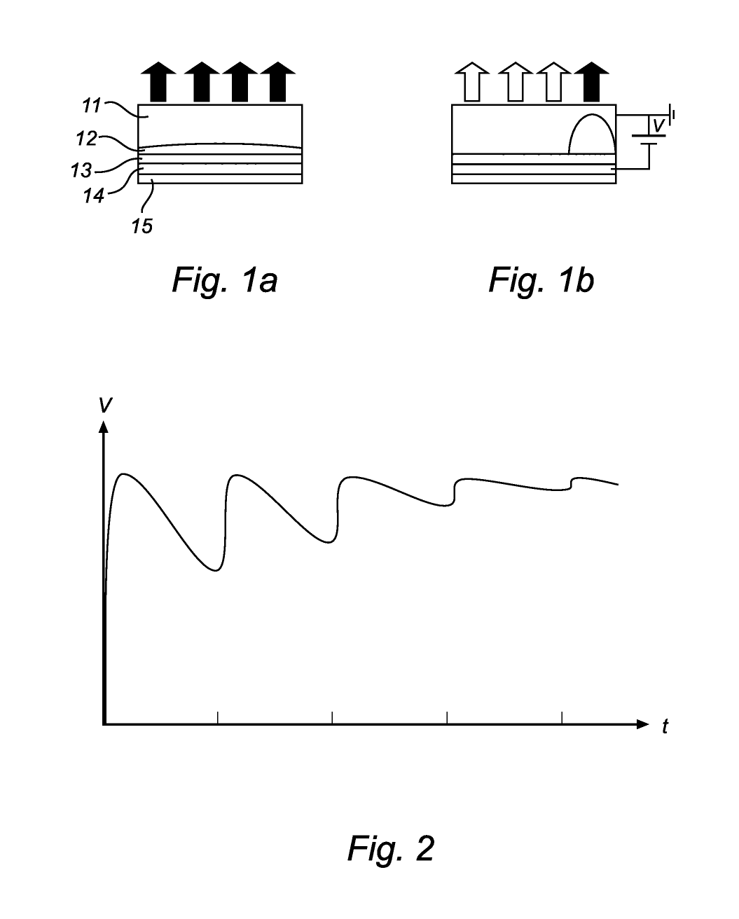

FIG. 1a shows a side view of a typical electrowetting display picture element in a colored state;

FIG. 1b shows a side view of a typical electrowetting display picture element in a white state;

FIG. 2 shows a diagram, in which voltage over a picture element is plotted as a function of time;

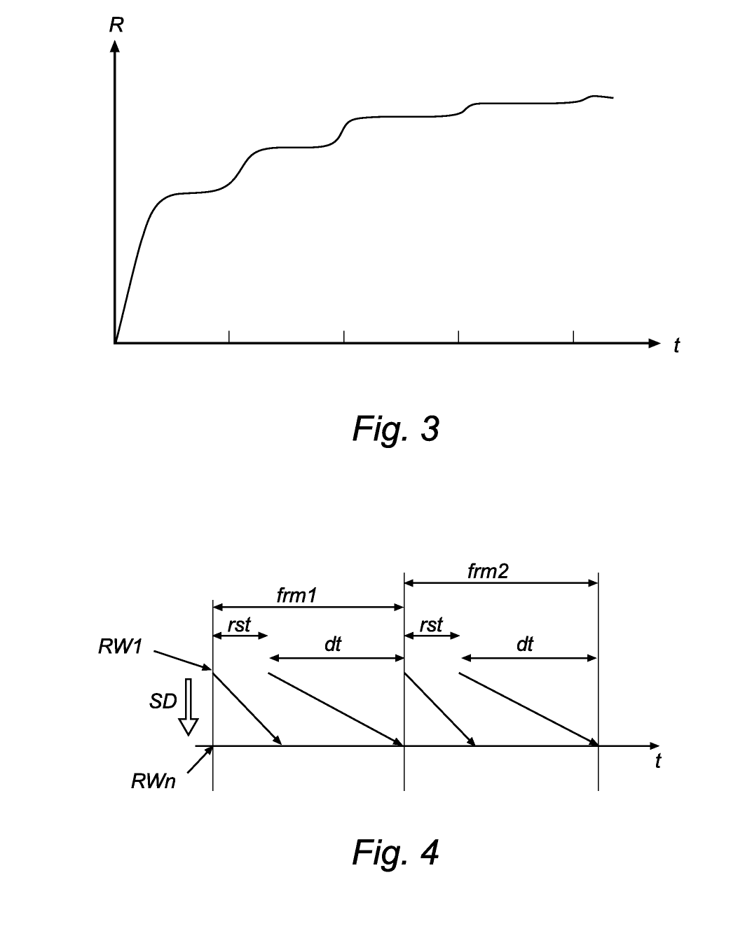

FIG. 3 shows a diagram, in which reflectivity of a picture element is plotted as a function of time;

FIG. 4 shows a timing diagram, in which a known method for resetting and writing of data to a picture element is depicted;

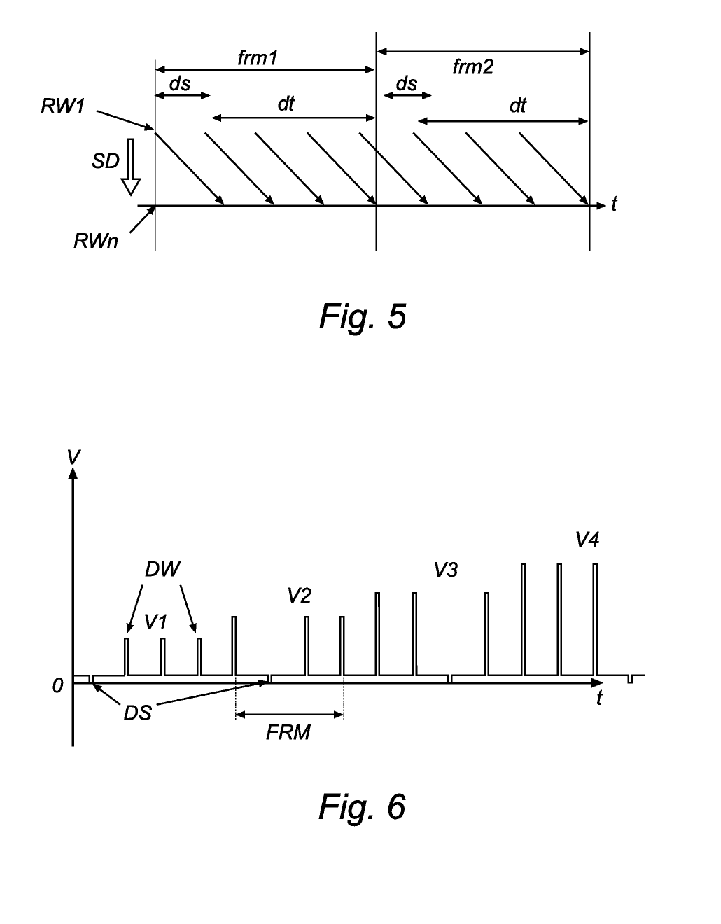

FIG. 5 shows a timing diagram, in which it is illustrated how to arrange the timing of a voltage signal and data write signal of a display device according to an embodiment of the present invention;

FIG. 6 shows a schematic diagram of an example of how to drive a picture element with multiple data writes to reduce the response time for reaching the intended voltage level in accordance with an embodiment of the invention; and

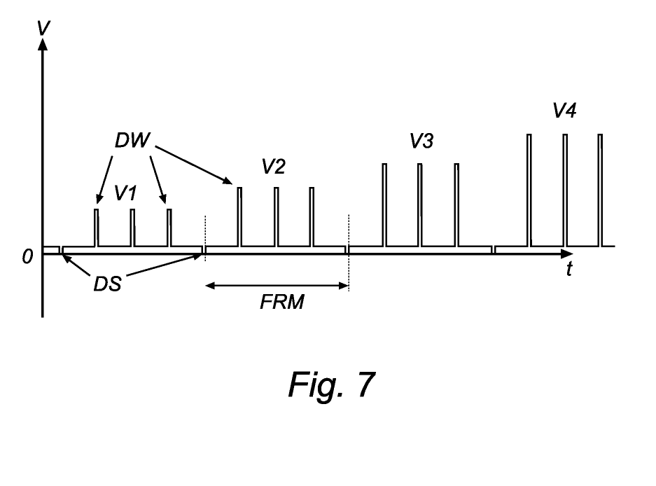

FIG. 7 shows a schematic diagram of another example of how to drive a picture element with multiple data writes to reduce the response time for reaching the intended voltage level with asynchronous voltage signals in accordance with another embodiment of the invention.

In FIG. 1a, there is shown an electrowetting cell comprising water 11, colored oil 12, a hydrophobic insulator 13, a transparent electrode 14 and a white substrate 15. There is no voltage applied to the cell, i.e. the picture element is in an off-state and consequently, the oil forms a colored homogeneous film. The black arrows indicate that the picture element appears dark.

FIG. 1b shows the same cell as in FIG. 1a, but there is a DC-voltage V applied to the cell, i.e. the picture element is in an on-state and consequently, the oil film is contracted. The white arrows indicate that the picture element appears white (or bright).

In general, a display device having electrowetting cells as above comprises an active matrix plane, which may be addressed using column and row drivers. The column drivers set the voltage levels of the picture elements and the row drivers select (or activate) a specific row, such that the voltage levels of the column drivers set the selected picture elements in the desired state. When writing data to a picture element of the display, the row of the picture element must be selected and an appropriate voltage level must be applied to the picture element column driver, in order for the picture element to be selected and written in accordance with the voltage level applied to the column driver. This addressing technique is usually known as matrix addressing.

In FIG. 2, there is shown a diagram illustrating the voltage V over a picture element of an active matrix electrowetting display as a function of time t. It should be understood that the voltage variations is a result of the fact that capacitance of the picture element changes as the voltage over the picture element changes. A voltage is sampled on the picture element capacitor by using active matrix addressing. Due to the change in capacitance in the picture element, the voltage level over the picture element will not reach its intended value. Thus, after a number of frame times with the same voltage level, the picture element approaches its intended value. Response time of a picture element is defined as the time it takes for a picture element to reach a predetermined optical state from the actual time of application of a voltage level representing the predetermined optical state

Referring to FIG. 3, the reflectivity R of a picture element as a function of time t is presented. In FIG. 3, it is shown that the reflectivity slowly increases and approaches the intended value.

Further, FIG. 4 shows a prior art timing diagram illustrating resetting of and applying data to picture elements. FIG. 4 shows a first frame frm1 and a second frame frm2. The first frame frm1 starts with a reset rst of the first row RW1 and continues in the scanning direction SD to the last row RWn, thus resetting all the rows of the display device. After resetting the last row, the first row RW1 is selected again and now data dt is written to the first row. In this manner, data is written to all the rows of the display device in the first frame frm1. Following the first frame, there is a second frame frm2, which comprises resetting and writing of data as above. The symbol, t, denotes time. The purpose of the reset signal is to set the picture element in a predetermined optical state regardless and typically different from the optical state of the picture element before application of the reset signal, so as to obtain a well-defined starting point for application of the data write signal. The resetting signal suppresses hysteresis effects in picture element addressing.

In FIG. 5, there is a timing diagram showing the timing of the voltage signal and the data write signal of a display device according to an embodiment of the present invention. The symbols ds, RW1, RWn, SD, dt, t, frm1 and frm2 denote voltage signal, the first row, the last row, scanning direction, a plurality of data signals, time, a first frame and a second frame respectively. Each frame comprises one voltage signal ds and a plurality of data write signals dt. The purpose of the voltage signal ds is to prevent undesired back flow of the oil and thus differs from the purpose of the reset pulse rst in FIG. 4. Moreover, unlike the signal rst which brings the picture element in a different optical state, the voltage signal dt is such that the optical state directly before and after applying the voltage signal dt is substantially the same. Although not wishing to be bound by any theory, the inventors believe that the voltage signal ds allows the picture element to discharge, hence the voltage signal is also referred to as a discharge signal. In FIG. 5, the frame time is 20 ms and, thus, an appropriate duration of the voltage signal is 2 ms.

With reference to FIG. 6, there is shown a schematic diagram, in which V on the vertical axis indicates voltage applied for refreshing of the picture elements and t denotes time on the horizontal axis. In FIG. 6, there is shown a number of frames FRM. The frames FRM may comprise a voltage signal DS, but it is not necessary that all frames comprise a voltage signal. The voltage levels V1, V2, V3 and V4 represent voltages applied to picture elements such that corresponding optical states are attained, for instance four different grey levels. The order, in which the voltage signal DS and the data write signals are transmitted within the frame may be arbitrary, i.e. asynchronous discharging is applied, but the order may also be arranged to reduce the number of resets and to increase the number of data writes. The data writes may then be synchronized with the frame frequency such that a frame always starts with a data write, for example, for the first row.

In FIG. 7, there is shown a schematic diagram, in which the same notation as in FIG. 6 has been used. The diagram illustrates another example of how to drive a display device according to an embodiment of the present invention. In this example each frame FRM starts with a voltage signal DS (thus each frame comprises one voltage signal for suppressing backflow). In this manner, the voltage signals DS are synchronized with the frames.

Even though the invention has been described with reference to specific exemplifying embodiments thereof, many different alterations, modifications and the like will become apparent for those skilled in the art. The described embodiments are therefore not intended to limit the scope of the invention, as defined by the appended claims.

1. Driving means for an electrowetting display device having a picture element, said driving means applying, prior to a data write signal, a voltage signal to said picture element, wherein said voltage signal has a duration and a voltage level that allow said picture element to maintain an optical state.

2. The driving means according to claim 1, wherein said driving means apply a plurality of data write signals to the picture element during a frame.

3. The driving means according to claim 1, wherein said driving means apply the voltage signal to a picture element having the optical state in a first frame such that the picture element has the same optical state in a second frame.

4. The driving means according to claim 1, wherein the voltage level of said voltage signal is less than one sixth of the data write signal voltage.

5. The driving means according to claim 4, wherein the voltage level of said voltage signal is zero volt.

6. The driving means according to claim 1, wherein said voltage signal has the duration of approximately 2-15% of a frame.

7. The driving means according to claim 6, wherein said voltage signal has the duration of approximately 10% of a frame.

8. The driving means according to claim 2, wherein said driving means apply at least one voltage signal to each picture element in said frame.

9. The driving means according to claim 1, wherein said driving means start said frame by applying the voltage signal to said picture element.

10. An electrowetting display device comprising a driving means and a picture element, the driving means applying, prior to a data write signal, a voltage signal to said picture element, wherein the voltage signal has a duration and a level for maintaining an optical state by the picture element.

11. A method for driving an electrowetting display device having a picture element, said method comprising:
applying, prior to a data write signal, a voltage signal to said picture element, wherein said voltage signal has a duration and a voltage level that allow said picture element to maintain an optical state while said voltage signal is applied.

12. The method according to claim 11 further comprising:
applying a plurality of data write signals to the picture element during a frame.

13. The method according to claim 11, wherein applying the voltage signal further comprises applying the voltage signal to a picture element, wherein the picture element has the same optical state in a first frame and in a second frame.

14. The method according to claim 11, wherein the voltage level of said voltage signal is less than one sixth of the data write signal.

15. The method according to claim 14, wherein the voltage level of said voltage signal is zero volt.

16. The method according to claim 11, wherein said voltage signal has a duration of approximately 2-15% of a frame.

17. The method according to claim 16, wherein said voltage signal has a duration of approximately 10% of a frame.

18. The method according to claim 12, wherein the applying the voltage signal comprises applying at least one voltage signal to each picture element in said frame.

19. The method according to claim 12, wherein applying the voltage signal is performed by applying the voltage signal at the start of said frame.
